(19) United States
(12) Patent Application Publication
(10) Pub. No.: US 2026/0067533 A1
(43) Pub. Date: Mar. 5, 2026

(54) TECHNIQUES FOR CLIENT-SIDE SEGMENT SPLICING OF LIVE STREAM MEDIA CONTENT

(71) Applicant: NETFLIX, INC., Los Gatos, CA (US)

(72) Inventor: Mark WATSON, San Francisco, CA (US)

(21) Appl. No.: 19/075,583

(22) Filed: Mar. 10, 2025

Related U.S. Application Data
(60) Provisional application No. 63/691,153, filed on Sep. 5, 2024.

(51) Int. Cl. H04N 21/44; H04N 21/2187; H04N 21/458

(52) U.S. Cl. CPC H04N 21/44016; H04N 21/2187; H04N 21/458

(57) ABSTRACT

In various embodiments, a method for client-side splicing of a media content stream comprises determining supplemental content begins at a first time indicated by a media event; downloading, based on the first time, a beginning portion of a first segment of the media content, wherein the first time coincides with a playback time period of the first segment; downloading, based on information included in the beginning portion of the first segment, one or more frames of the first segment that occur prior to the first time; and outputting the one or more frames of the first segment that occur prior to the first time.

### CROSS-REFERENCE TO RELATED APPLICATIONS

This application claims priority benefit of the United States Provisional Patent Application titled “TECHNIQUES FOR STREAMING LIVE MEDIA CONTENT WITH EVENTS” filed on Sep. 5, 2024, and having Serial No. U.S. 63/691,153. The subject matter of this related application is hereby incorporated herein by reference.

### BACKGROUND

### Field of the Various Embodiments

The various embodiments relate generally to computer science and media content streaming and, more specifically, to techniques for client-side segment splicing of live stream media content.

### DESCRIPTION OF THE RELATED ART

Live streaming of media content is the process of continuously transmitting real-time media content over a network for playback by client applications. Because of the real-time nature of live stream media content, supplemental content, such as advertisement breaks and other program content (e.g., intro/outro credits, chapters, blackouts, and extensions), oftentimes needs to be inserted in real-time into the live stream of the media content. Most media content associated with live streaming events are encoded before arriving at the client application for playback. Encoding is the process of converting raw digital content into a suitable format for storage, transmission, and/or display. Typically, the encoding process breaks up the media content item into segments of a certain length (e.g., 2 seconds). In many cases, segments on either side of supplement content are of a different duration to accommodate the placement of the supplemental at a segment boundary. The real-time dynamic insertion of supplemental content into media content being streamed requires splicing segments of the media content that surround the supplemental content. Media events, which are indicators of the start and end splice points of supplemental content, can be included in a manifest that also includes information on the live stream media content in order to indicate where the supplemental content should be spliced into the media content segments.

Conventional approaches to splicing segments of live stream media content to insert supplemental content include server-side ad insertion (SSAI) and server guided ad insertion (SGAI). With SSAI, the insertion of supplemental content occurs before transmitting an updated manifest to a client application. With SGAI, a manifest is sent to the client with splice points indicating where supplemental content should be inserted. When the playback of the live stream reaches a splice point, the client application requests the associated supplemental content from the server. Because the client is requesting the supplemental content associated with the splice point, the server can determine the supplemental content based on preferences of the requesting client. Both SSAI and SGAI insert supplemental content by instructing the server to splice media segments around the segment boundaries of the segment and insert the supplemental content in between the segment boundaries.

One drawback of SSAI and SGAI is that both approaches incur a trade-off of maintaining a cadence of, for example, 2 second durations for each segment or interrupting the cadence by splicing the segments into shorter durations. Maintaining a fixed cadence allows for efficient mapping of media events, such as indicators for the start and end splice points of supplemental content, to the specific segment numbers, but constrains possible splice points for supplemental content insertion. For example, if media segments occur at a fixed cadence of every 2 seconds starting at 0 seconds, every even number in time marks a segment boundary. If a fixed cadence is used and splicing occurs only at segment boundaries, then supplemental content can only be inserted at the even intervals of time, which limits the options for inserting supplemental content.

The above limitation is an impractical constraint for many streaming operations, especially in the case of real-time live streaming of media content. On the other hand, variable cadence allows for arbitrary splice points for supplemental content insertion. However, variable cadence introduced by shortening the duration of segments during supplemental content insertion requires manifest polling to learn the mappings of the media events, such as indications of the start and end times of supplemental content, to segment numbers. For example, if each segment is 2 seconds long and supplemental content is indicated to be inserted at 3 seconds based on a media event, where the next segment boundary occurs may be unclear. New information, such as an updated manifest, is needed to determine the next segment boundary and future segment boundaries.

Manifest polling is the process of frequently downloading updates to the manifest in order to learn the segment boundaries at the start of the supplemental content and return to playback of the media content before the supplemental content concludes. However, manifest polling wastes network bandwidth with frequent repeat downloading of the same manifest data. Manifest polling also delays requests for media content segments using the information in the manifests because an updated manifest must always be fetched first. Furthermore, in the SSAI approach, updated manifests must be crafted individually for each client receiving different personalized supplemental content. This results in the manifest updates being ineligible for edge caching and sharing between clients, significantly limiting the scalability of the approach.

As the foregoing illustrates, what is needed in the art are more effective techniques for inserting supplemental content into live stream media content.

### SUMMARY

One embodiment sets forth a computer-implemented method for client-side splicing of a media content stream. The method includes determining supplemental content begins at a first time indicated by a media event. The method further includes downloading, based on the first time, a beginning portion of a first segment of the media content, where the first time coincides with a playback time period of the first segment. The method also includes downloading, based on information included in the beginning portion of the first segment, one or more frames of the first segment that occur prior to the first time. Furthermore, the method includes outputting the one or more frames of the first segment that occur prior to the first time.

At least one technical advantage of the disclosed techniques relative to the prior art is that the disclosed techniques allow arbitrary splice points for inserting supplemental content into media content associated with a live streaming event, while maintaining a fixed cadence based on when the next media segment occurs. By maintaining a fixed cadence, the disclosed techniques allow for efficient mapping of media events, such as indications of start and end times of supplemental content, to the segment numbers of media content without manifest polling. Furthermore, by supporting arbitrary splicing points for insertion of supplemental content into media content, the disclosed techniques allow for greater control and more efficient supplemental content insertion. Additionally, because the supplemental content insertion is performed by the client application, the disclosed techniques utilize the processing power of the client device, rather than burdening the server, and allow for real-time targeting and personalization of supplemental content based on the preferences of a client application or a user of a client application. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a block diagram of a computer-based system configured to implement one or more aspects of the various embodiments;

FIG. 2 is a more detailed illustration of the manifest server of FIG. 1, according to various embodiments;

FIG. 3 is a more detailed illustration of a user device of FIG. 1, according to various embodiments;

FIG. 4 is a more detailed illustration of the manifest server and live origin server of FIG. 1, according to various embodiments;

FIG. 5 is a more detailed illustration of the client application of FIG. 1, according to various embodiments;

FIG. 6 illustrates a timeline diagram of exemplary media segments and supplemental content indicated by media events, according to various embodiments; and

FIG. 7 is a flow diagram of method steps for splicing supplemental content indicated by a media event into media content, according to various embodiments.

### DETAILED DESCRIPTION

In the following description, numerous specific details are set forth to provide a more thorough understanding of the various embodiments. However, it will be apparent to one of skill in the art that the inventive concepts can be practiced without one or more of these specific details.

As described, one drawback of conventional approaches to splicing segments of live stream media content to insert supplemental content, such as server-side ad insertion (SSAI) and server guided ad insertion (SGAI), is that these approaches incur a trade-off of maintaining a cadence of, for example, 2 second durations for each segment or interrupting the cadence by splitting the segments into shorter durations. Maintaining a fixed cadence allows for efficient mapping of media events, such as the start and end splice points of supplemental content, to the specific segment numbers, but constrains the overall possible splice points for supplemental content insertion. If a fixed cadence is used and splicing occurs only at segment boundaries, then supplemental content can only be inserted at the even intervals of time, which limits the options for inserting supplemental content. On the other hand, variable cadence allows for arbitrary splice points for supplemental content insertion. However, variable cadence introduced by shortening the duration of segments during supplemental content insertion requires manifest polling to learn the mappings of the media events, such as the start and end splice points of supplemental content, to segment numbers. In particular, new information, such as an updated manifest, can be required to determine a next segment boundary. For example, manifest polling is the process of frequently downloading updates to the manifest in order to learn the segment boundaries at the start of the supplemental content and return to playback of the media content before the supplemental content concludes. However, manifest polling wastes network bandwidth with frequent repeat downloading of the same manifest data and delays requests for the media content segments because the updated manifest must always be fetched first. Furthermore, in the SSAI approach, updated manifests must be crafted individually for each client receiving different personalized supplemental content. This results in the manifest updates being ineligible for edge caching and sharing between clients, significantly limiting the scalability of the approach.

The disclosed techniques provide client-side splicing of segments of media content, including media content associated with live streaming events. During playback of media content, a client application determines the next supplemental content to be inserted into the media content based on media events indicating a start time of the next supplemental content and an end time of the next supplemental content from an associated manifest or media events track. The client application downloads a portion of a first segment of media content that coincides with a start time of the next supplemental content and includes a first movie fragment box. The first movie fragment box includes information related to each frame in the segment, including the size of the frames and the timing of each frame. Based on the information included in the first movie fragment box and the media event, the client application downloads the frames of the segment that occur before the start time of the supplemental content. The start time indicated by the media event should align with a splice point in the media content (i.e., an instantaneous decoder refresh (IDR) frame). However, if the start time is misaligned with the splice point, the client application can modify the start time of the supplemental content, indicated by the media event, to align with the nearest IDR frame in the media content. The movie fragment box includes information about the location of the IDR frames in the media content. The client application plays back the downloaded frames and then the supplemental content. Based on the length of the supplemental content, which the client application determines from the manifest or media events track, the client application determines a second segment of the media content that coincides with the end time of the supplemental content. The client application downloads a portion of the second segment that coincides with the end time of the supplemental content and includes a second movie fragment box. The second movie fragment box includes information related to each frame in the second segment, including the size of the frames and the timing of each frame. Based on the information included in the second movie fragment box and the media event, the client application downloads the frames in the second segment that occur after the end time of the supplemental content. Likewise, the end time indicated by the media event should align with a splice point in the media content (i.e., an IDR frame). However, if the end time is mis-aligned with the splice point, the client application can modify the end time of the supplemental content, indicated by the media event, to align with the nearest IDR frame in the media content. The client application plays back the downloaded frames of the second segment after the playback of the media event concludes.

At least one technical advantage of the disclosed techniques relative to the prior art is that the disclosed techniques allow arbitrary splice points for inserting supplemental content into media content associated with a live streaming event, while maintaining a fixed cadence based on when the next media segment occurs. By maintaining a fixed cadence, the disclosed techniques allow for efficient mapping of media events, such as indications of start and end time of supplemental content, to the segment numbers of media content without manifest polling. Furthermore, by supporting arbitrary splicing points for insertion of supplemental content into media content, the disclosed techniques allow for greater control and more efficient supplemental content insertion. Additionally, because the supplemental content insertion is performed by the client application, the disclosed techniques utilize the processing power of the client device, rather than burdening the server, and allow for real-time targeting and personalization of supplemental content based on the preferences of a client application or a user of a client application.

### System Overview

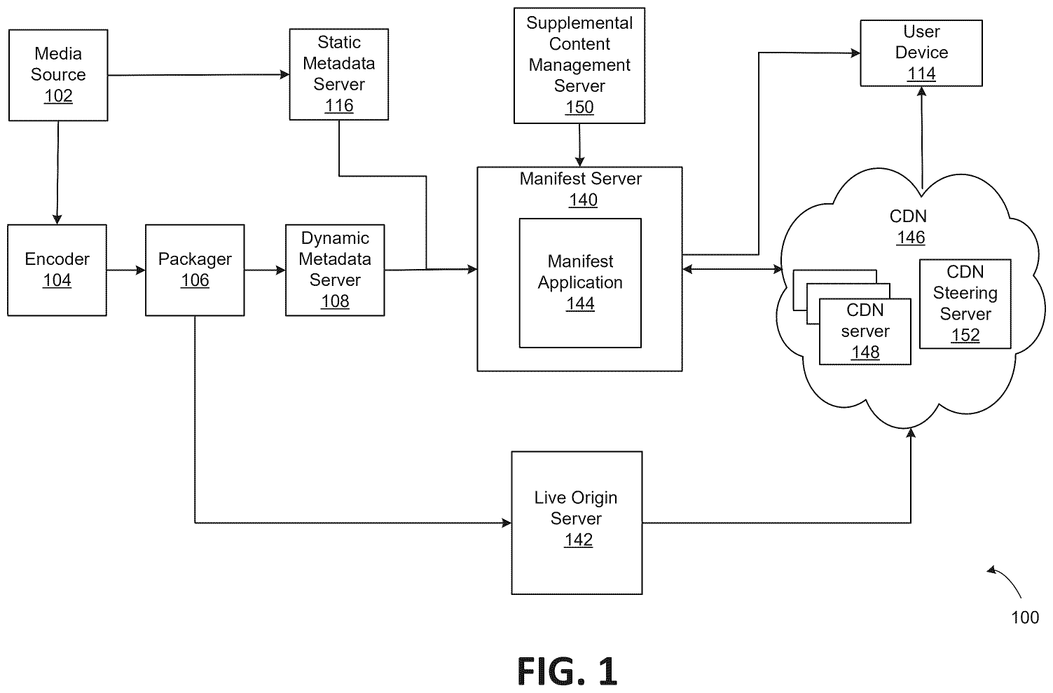

FIG. 1 illustrates a block diagram of a computer-based system 100 configured to implement one or more aspects of the various embodiments. As shown, system 100 includes, without limitation, a media source 102, an encoder 104, a packager 106, a dynamic metadata server 108, a static metadata server 116, a supplemental content management server 150, a manifest server 140, a live origin server 142, one or more user devices 114, and a CDN 146 that includes one or more CDN servers 148 and a CDN steering server 152. Each of the various aspects of system 100 can be connected to each other in any technically feasible manner, such as via the Internet, a local area network (LAN), a wireless network, etc.

Media source 102 is a source of digital media data. For example, media source 102 could be a transmission truck connected to one or more cameras and one or more microphones that capture a live streaming event, such as a live concert or sports game. As another example, media source 102 could be a network operations center to which a transmission truck sends an uncompressed media data signal. In some embodiments, media source 102 can be a system component that is located at a premises external to the premises of the other aspects of system 100, such as a transmission truck located near where a live media feed is being captured. Although shown as directly communicating with encoder 104 for simplicity, in some embodiments, media source 102 can communicate with a media connector that interfaces with media source 102 to receive transmitted media data, terminate the transmission, and extract video streams from the transmitted data. In such cases, the media connector can enable the exchange of various types of media, such as audio, video, and text, by supporting different protocols and data formats, and the media connector can incorporate hardware and/or software to manage data translation, signal conversion, or protocol adaptation, ensuring appropriate routing of media content across diverse environments.

In some embodiments, media source 102 is configured to embed supplemental content, discussed in greater detail below, into the media content associated with a live streaming event during real-time recording of the media content. For example, software at the transmission truck or network operations center, described above, can provide a user interface (UI) for users to manually trigger supplemental content and/or can support automatically scheduled supplemental content. Media source 102 is also configured to send the media content to encoder 104. In addition, media source 102 is configured to send static metadata to static metadata server 116 and encoder 104. Static metadata can be determined by media source 102 in advance of embedding the supplemental content into the live stream of media content. Static metadata can include downloadable information associated with the media content, such as one or more audio tracks, one or more video tracks, and a media events track. For example, the static metadata can include the bitrate, language, and other information associated with the tracks. Although described herein primarily with respect to static metadata being received from media source 102 as a reference example, in some embodiment, static data about the tracks can also or alternatively be received from the encoder 104 and/or the packager 106.

Encoder 104 is specialized software and/or hardware designed to encode audio, video, and text data. Encoding is the process of converting raw digital content into a suitable format for storage, transmission, and/or display. Encoder 104 can process various types of content, such as audio, video, and/or text, by applying compression algorithms and encoding schemes to transform raw data content into one or more optimized, standardized formats. Encoder 104 can support multiple encoding standards and codecs to accommodate different content types and delivery platforms. For example, encoder 104 can perform video transcoding and generate different audio/video bit rates and segment encoded video to small chunks for distribution. Encoder 104 is configured to receive media content with embedded events and associated static metadata from media source 102. In some embodiments, encoder 104 extracts the embedded events from the media content and converts the received data into a moving picture experts group 4 part 14 (MPEG-4 Part 14 or MP4) file format. Encoder 104 is also configured to determine dynamic metadata for one or more media events, each associated with supplemental content, that is extracted from the media content. Dynamic metadata can be determined when the live stream of the media content begins and can include, for each of any number of media events, a start time, media presentation duration, presentation time offset, start segment number, segment uniform resource locator (URL) templates, media timescale, and segment duration, each associated with supplemental content. Encoder 104 is configured to send the dynamic metadata, the encoded media content, and the media events track to packager 106 for packaging, as discussed in greater detail below.

As used herein, “supplemental content” includes content not included in the main media content program/stream, such as advertisement breaks and other program content, such as intro/outro credits, chapters, blackouts, and extensions. As used herein, “media event” and “event” are used interchangeably to refer to data regarding timing and frame-accurate information about transitional points (i.e., splice points) of the supplemental content that is embedded in media content associated with a live streaming program. Media events can indicate a period in the media content stream that either contains supplement content or is intended to be replaced by supplemental content. The action of inserting, removing, or replacing the supplemental content into or from the media content stream can be conducted by other means. Media events can align with specific frames in a video stream. Media events can be defined in any suitable format, such as the Digital Program Insertion Cueing Message (SCTE-35), which is the core signaling standard for advertising and program/distribution control of content for content providers/distributors. SCTE-35 signals can be used to identify supplemental content breaks, such as advertisement breaks, program content, such as intro/outro credits, chapters, blackouts, and extensions when a live stream, such as a stream for a sporting game, continues after the allotted time. SCTE-35 supports the splicing of media content streams for the purpose of media content insertion, which includes advertisements and other forms of supplemental content. SCTE-35 defines an in-stream messaging mechanism to signal information related to splicing and insertion opportunities. SCTE-35 is configured to carry notifications of upcoming insertion or splicing points and other timing information in the transport stream. The following table describes four example events that can be used in the techniques disclosed herein:

| | Point, | | |
|---|---|---|---|
| | timespan, | | |
| Event | or infinite | Purpose | SCTE-35 message |
| Program Start | Point | Indicates | time_signal( ) |
| | | the start of | splice_time( ) |
| | | the live | splice_descriptor( ) |
| | | program. | splice_descriptor_tag = 2 |
| | | | (segmentation_descriptor) |
| | | | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 0 |
| | | | delivery_not_restricted_flag = 1 |
| | | | segmentation_upid_type = 0 |
| | | | segmentation_type_id = 0x10 (Program |
| | | | Start) |
| | | | segment_num = 1 |
| | | | segments_expected = 1 |
| Program End | Point | Indicates | time_signal( ) |
| | | the end of | splice_time( ) |
| | | the live | splice_descriptor( ) |
| | | program. | splice_descriptor_tag = 2 |
| | | | (segmentation_descriptor) |
| | | | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 0 |
| | | | delivery_not_restricted_flag = 1 |
| | | | segmentation_upid_type = 0 |
| | | | segmentation_type_id = 0x11 (Program |
| | | | End) |
| | | | segment_num = 1 |
| | | | segments_expected = 1 |
| Ad Break | Timespan | Indicates | time_signal( ) |
| | | the time and | splice_time( ) |
| | | expected | splice_descriptor( ) |
| | | duration of | splice_descriptor_tag = 2 |
| | | an ad | (segmentation_descriptor) |
| | | break. | ... |
| | | | segmentation_event_id = x |
| | | | segmentation_event_cancel_indicator = |
| | | | 0 |
| | | | ... |
| | | | program_segmentation_flag = 1 |
| | | | segmentation_duration_flag = 1 |
| | | | segmentation_duration( ) |
| | | | delivery_not_restricted_flag = 1 |
| | | | segmentation_upid_type = 0 |
| | | | segmentation_type_id = 0x34 |
| | | | (Placement Provider Opportunity Start) |
| | | | segment_num = 0 |
| | | | segments_expected = 0 |
| Ad Break Early | Point | Indicates | time_signal( ) |
| Termination | | the end time | splice_time( ) |
| | | of an ad | splice_descriptor( ) |
| | | break in the | splice_descriptor_tag = 2 |
| | | case of | (segmentation_descriptor) |
| | | early return | ... |
| | | (ad break | segmentation_event_id = x |
| | | ends early) | segmentation_event_cancel_indicator = |
| | | | 1 |

Regarding the SCTE-35 column in the above table, time_signal( ) commands are used to insert new content at a splice point at the splice_time( ). Furthermore, splice_descriptor( ) describes information related to the splice such as a segmentation_event_id. The segmentation_event_id can be a number used as identification for the specific media event. The segmentation_event_cancel_indicator in combination with the segmentation_event_id can be used to indicate that a specific media event should be canceled. For example, the Ad Break Early Termination media event in the table above is used to modify the duration of a previous stored Ad Break media event or remove the media event entirely if the associated supplement content has not occurred yet.

In some embodiments, media events data includes dynamic metadata and a set of media event records, as defined in the tables below:

### Media Events Metadata:

| Data Element | Type | Mandatory | Description |
|---|---|---|---|
| timescale | number | Yes | Timescale for the presentation time |
| | | | offset and the media events |
| | | | timestamps |
| eventBaseTime | number | Yes | This is the millisecond (ms) time |
| | | | from which event timestamps are |
| | | | measured. |
| mediaEventsCutoffTime | number | Yes | The is the ms time beyond which |
| | | | events are not included in the |
| | | | manifest. All events that occurred |
| | | | before this time can be included. |

### Media Event Record:

| Data Element | Type | Mandatory | Description |
|---|---|---|---|
| type | enum | Yes | One of {Program Start, Program End, Ad |
| | | | Break} |
| | | | When the event is delivered in a media |
| | | | events track, this is the |
| | | | segmentation_type_id from the SCTE-35 |
| | | | message. |
| | | | Ad Break and Ad Break Start are |
| | | | synonymous. |
| id | number | No | Mandatory for events that can be |
| | | | cancelled or modified, such as Ad Break. |
| | | | When the event is delivered in a media |
| | | | events track, this is the |
| | | | segmentation_event_id from the SCTE |
| | | | message (and not the ID from the |
| | | | EventMessageInstance boxes layer) |
| timestamp | number | Yes | The timestamp, in the timescale included |
| | | | in the metadata, of the event, or the start |
| | | | of the event. |
| | | | This is specified as an offset from the |
| | | | eventBase Time. |
| | | | When the event is delivered in a media |
| | | | events track, this is the sum of the media |
| | | | events track sample Decode Time Stamp |
| | | | (DTS) (also equal to Composition Time |
| | | | Stamp (CTS) and Presentation Time) with |
| | | | the presentation_time_delta from the |
| | | | EMIB layer |
| duration | number | No | The duration of the event in the timescale |
| | | | included in the metadata. |
| | | | This is only needed when type = Ad Break |
| | | | When the event is delivered in a media |
| | | | events track, this is the event_duration |
| | | | field from the EMIB layer. |

The time periods spanned by media events can be non-overlapping in some embodiments. Encoder 104 is configured to support canceling or modification of media events. Encoder 104 is configured to remove or modify any canceled or modified media events on reception of a cancel or modify instruction from media source 102 (e.g., only one of the original media event or the cancelled/modified media event can exist at the same time). Alternatively, an End event may be sent to indicate early termination of supplemental content, for example for an Ad Break Start event may be paired with an Ad Break End event.

In some embodiments, the media events can have a separate timescale than the audio, video, text stream of media content associated with a live streaming event. In some embodiments, the media events can have the same timescale as the video track of the live stream. To derive the time of an event, the timestamp of a specific event can be converted to ms and added to the eventBaseTime. To identify the video frame associated with a specific event, the ms-rounded video frame timestamp can be compared with the ms-rounded event timestamp, or equivalently 1 ms can be added to the event timestamp and rounded down to the nearest video frame.

The media events track is a data track, such as an mp4 track, that describes regions of live content that include supplemental content, each of which can begin during a given media content at a specific timestamp indicated by a media event, can have a duration from a start time to an end time, or can have an infinite or indefinite duration. Adaptive streaming with Dynamic Adaptive Streaming over HTTP (DASH) or Hypertext Transfer Protocol Live Streaming (HTTP Live Streaming or HLS) requires the content to be segments. Therefore, in some embodiments, the media events track is segmented for delivery similar to an audio, video, or text mp4 track. The same media event can correspond to one or more segments depending on the length of the media event. In some embodiments, the media events track describes media events by reference to an event message box (EMSG). In some embodiments, segments of a media events track can include a standard mp4 track structure indicating the timing, size and position of the media content (e.g., Track Run Box (trun)).

In some embodiments, segments of a media events track can include either one or more EventMessageInstance boxes (EMIB) or a single EventMessageEmptyBox (EMEB). In the media events track format, the presentation time and duration (if present) of the media events appear in explicit fields within the EMIB as well as within a SCTE-35 message data. Client applications can rely on the explicit fields in the EMIB and do not need to interpret the fields within the message data. In some embodiments, the only requirement for interpreting the SCTE-35 message data is to determine the event type and for event cancellation the ID and cancellation flag. In such cases, SCTE-35 events can be identified with the Uniform Resource Name (URN) urn:scte:scte35:2013:bin in the scheme_id_uri field of the EMIB. The value field can be empty and the message_data field can include the SCTE-35 message in binary form.

The media events history includes the media events metadata and the set of media events indicating the start and end times of supplemental content that have occurred prior to time T. The value of T is included in the dynamic metadata as mediaEventsCutoffTime.

A point event is a type of media event, such as a Program Start, that has a single timestamp but zero duration, can appear in a segment including the timestamp of a media event, and can appear in subsequent segments for a pre-defined period of seconds, such as 10 seconds, 20 seconds, 30 seconds, or a similar other predefined duration. The point event can appear in earlier segments if known earlier. The event_duration field of a point event can be set to zero, but the sample duration at the mp4 layer can be the pre-roll duration, or 1 tick if there is no pre-roll. A timespan event is associated with supplemental content, such as an advertisement break, that has a start timestamp and an end timestamp, and can appear in all segments whose timespan intersects with the event timespan.

Encoder 104 is configured to perform stream conditioning at the video frame indicated in the splice_time( ) field of each of the four messages defined above, and at the video frame indicated by the sum of splice_time( ) and break_duration( ) provided that no End event indicating the end of a media event is received before such a time. Stream conditioning is the adaptation of the media encoding to ensure that the video can be seamlessly spliced at the frame identified as a splice point. For a splice in point (transition into the live stream, e.g., end of an event), the frame must be an I-frame, which are frames encoded without reference to any other frame except for (parts of) the I-frame. For a splice out point (transition out of the live stream, e.g., start of an event), frames before the splice point in presentation time cannot have encodings that depend on frames after the splice point. To achieve the foregoing, encoder 104 converts the splice point frame (the first frame that is not rendered from the live stream at the splice) into an I-frame.

Packager 106 includes a publishing server (not shown) that can create, manage, and distribute digital content across a network. Packager 104 can manage the workflow for content updates, ensuring that content is properly prepared and formatted for dissemination. Packager 106 can include any software for content management, authentication, and distribution automation. Packager 106 can receive encoded media content, dynamic metadata, and the media events track from encoder 104. Packager 106 can package the received encoded media content, dynamic metadata, and the media events track using transmultiplexing. Transmultiplexing is the process of changing the container format of an audio or video file without modifying the original content. For example, packager 106 can receive encoded media content in the mp4 format from the encoder and convert the encoded media content into a distributable package for output according to a format such as the HLS format or the DASH format. Packager 106 can send the dynamic metadata to dynamic metadata server 108. Packager 106 can send the media content packages, and the media events track to live origin server 142. Packager 106 can be a separate entity or coupled to the encoder 104.

Dynamic metadata server 108 is configured to receive dynamic metadata of media events associated with supplemental content embedded in media content. In operation, dynamic metadata server 108 verifies the dynamic metadata of each event contains the mandatory data, as described in the tables above. Dynamic metadata server 108 is configured to make the media events available to any server device or application, such as manifest application 144, for use in creating manifests.

Static metadata server 116 is a server that is configured to receive static metadata associated with media content. The static metadata can include downloadable information associated with one or more tracks associated with the media content, such as a video track(s), audio track(s), and/or a media events track. In some embodiments, static metadata for video and/or audio tracks can include additional information associated with bitrate, language, and other relevant information. In some embodiments, static metadata for media events tracks can include information that denotes the existence of the track. Static metadata server 116 sends the static metadata to manifest server 140.

Supplemental content management server 150 is a server that is configured to receive one or more supplemental content plan requests from manifest server 140. A supplemental content plan request can include the positions and durations of media events associated with supplemental content embedded in previously live streamed media content. Supplemental content management server 150 is configured to, based on the information in the supplemental content plan request, determine a supplemental content plan that includes positions, selected from the positions and durations that are supplied from a manifest for a media content, where embedded supplemental content should be removed and/or replaced with one or more new supplemental content. Supplemental content management server 150 then sends the supplemental content plan to manifest server 140.

Live origin server 142 is a server device configured to transmit media content (e.g., video, audio, and/or media events track) associated with live streaming events to one or more user devices 114 via CDN 146. Live origin server 142 is considered the source of truth for the media content associated with live streaming events. In some embodiments, live origin server 142 can be one or more server devices included in and/or replaced with any type of virtual computing system, distributed computing system, and/or cloud computing environment, such as a public, private, or a hybrid cloud system along with other server devices, such as manifest server 140. In some embodiments, live origin server 142 is configured to receive a request for media content from user device 114 via CDN 146 if the media content requested is not currently cached at one or more CDN servers 148 associated with CDN 146. In response to the request for media content, live origin server 142 transmits the requested media content (e.g., video, audio, and/or media events track) to the user device 114. CDN 146 can also cache the requested media content at one or more CDN servers 148 for future transmission to one or more user devices 114.

In some embodiments, live origin server 142 can include a software application, such as a live origin application that is stored in memory of live origin server 142 and executes on one or more processors of live origin server 142. In some embodiments, live origin application is a separate server device included in and/or replaced with any type of virtual computing system, distributed computing system, and/or cloud computing environment, such as a public, private, or a hybrid cloud system. The live origin application is configured to receive and store various data associated with media content that live origin server 142 makes available. Illustratively, the live origin application receives, for media content associated with each live streaming event that live origin application 142 makes available, one or more media content tracks (e.g., audio and/or video) and a media events track from packager 106.

Manifest server 140 is a server device configured to transmit one or more manifests associated with live streaming events to one or more user devices 114 based on one or more manifest requests. Illustratively, manifest server 140 includes, without limitation, a manifest application 144. In some embodiments, manifest server 140 can be included in and/or replaced with any type of virtual computing system, distributed computing system, and/or cloud computing environment, such as a public, private, or a hybrid cloud system along with other server devices, such as live origin server 142. Manifest server 140 is configured to receive one or more manifest requests from one or more user devices 114, static metadata from static metadata server 116, dynamic metadata from dynamic metadata server 108, and event plans from the supplemental content management server 150.

Manifest application 144 is a software application that is stored in memory of manifest server 140 and executes on one or more processors of manifest server 140. Manifest application 144 is configured to receive manifest requests. Furthermore, manifest application 144 is configured to generate and make available, for media content associated with a live streaming event, a manifest that specifies one or more video tracks, audio tracks, and/or timed text tracks, which permits a client application (e.g., a client application running in one of user devices 114) to download and play back any portion of the media title in accordance with a combination of the tracks specified in the manifest. In some embodiments, one of the tracks specified by the manifest is a media events track associated with the same media content. In addition, the manifest includes a data structure specifying the media events indicating the start and end times of supplemental content that have occurred so far in the media content (up to the latest media event received by manifest server 140 from dynamic metadata server 108). For example, the data structure can indicate the media events up to a mediaEventsCutoffTime, which is the time (ms time) up to which the events have been received.

User devices 114 are electronic devices that individuals utilize to interact with digital content or services over a network. User devices 114 can include, but are not limited to, personal computers, laptops, smartphones, tablets, smart TVs, gaming consoles, and/or wearable devices such as smartphones with an application to stream media content. Client applications (not shown) running on user devices 114 can connect to and communicate with server device 140 or other network components to access, consume and manipulate content or engage in various digital activities, such as streaming media content. Client devices 112 can include processors, memory, communication interfaces, and user interfaces.

CDN steering server 152 is a server device that manages one or more CDNs servers 148 in CDN 146. CDN servers 148 are used to store and deliver media content to one or more user devices 114. CDN steering server 152 is configured to determine which CDN servers within CDN servers 148 to use for delivery of media content. In some embodiments, when multiple CDNs are used, CDN steering server 152 can determine which CDN among the multiple CDNs to use for delivery of media content, and load-balancing mechanisms inside the CDN can select a particular CDN server. In some embodiments, the determination of which CDN servers within CDN servers 148 to use can be based on, without limitation, analyzing data from one or more user devices 114, CDN logs, network traffic load, and/or a steering manifest that describes which CDN server 148 should be used. CDN steering server 152 provides more control, flexibility, and near real-time responsiveness to requests from user devices due to the ability to dynamically switch between CDN servers 148 for delivery of media content. In some embodiments, CDN steering server 152 can determine to not use a CDN server within CDN servers 148 and request media content from live origin server 146 instead. Such determination can be based on CDN servers 148 not having previously or recently cached the requested media content. In some embodiments, CDN steering server 152 can also provide, to manifest server 140, information (e.g., URLs) about where media content tracks are stored in CDN 146. In such cases, manifest server 140 can generate manifests that include such media content tracks as well as associated URLs that client applications can access to download the media content tracks.

System 100 is shown herein for illustrative purposes only, and variations and modifications are possible without departing from the scope of the present disclosure. For example, the number and types of servers, and/or the number of user devices can be modified as desired. Further, the connection topology between the various units in FIG. 1 can be modified as desired. In some embodiments, any combination of the server(s) and/or user devices can be included in and/or replaced with any type of virtual computing system, distributed computing system, and/or cloud computing environment, such as a public, private, or a hybrid cloud system.

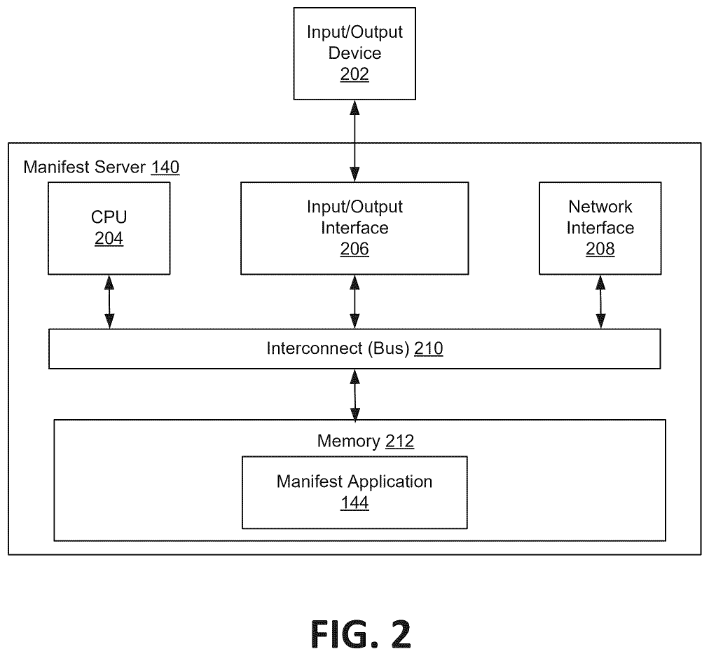

FIG. 2 is a more detailed illustration of manifest server 140 of FIG. 1, according to various embodiments. As shown, manifest server 140 includes, without limitation, a central processing unit (CPU) 204, an input/output (I/O) interface 206, a network interface 208, an interconnect (bus) 210, and a system memory 212.

CPU 204 is configured to retrieve and execute programming instructions, such as manifest application 144, stored in system memory 212. Similarly, CPU 204 is configured to store application data (e.g., software libraries) and retrieve application data from memory 212. Interconnect 210 is configured to facilitate transmission of data, such as programming instructions and application data, between CPU 204, I/O interface 206, network interface 208, and system memory 212. I/O interface 206 is configured to receive input data from I/O devices 202 and transmit the input data to CPU 204 via interconnect 210. For example, I/O devices 202 can include one or more buttons, a keyboard, a mouse, and/or other input devices. I/O interface 206 is further configured to receive output data from CPU 204 via interconnect 210 and transmit the output data to I/O devices 202.

A network interface 208 is configured to transmit and receive packets of data via a network (not shown). In some embodiments, network interface 208 is configured to communicate using the well-known Ethernet standard. Network interface 208 is coupled to CPU 204 via interconnect 210.

Memory 212 includes a manifest application 144. Manifest application 144 is a software application that is stored in memory of manifest server 140 and executes on one or more processors (e.g., CPU 204) of manifest server 140. Manifest application 144 is configured to generate, for media content associated with a live streaming event, a manifest that specifies one or more video tracks, audio tracks, and/or timed text tracks. The manifest permits a client application (e.g., a client application running in one of user devices 114) to download and play back any portion of the media title in accordance with a combination of the tracks specified in the manifest. In some embodiments, one of the tracks specified by the manifest is a media events track associated with the same media content. In addition, the manifest includes a data structure specifying the media events indicating the start and end times of supplemental content that have occurred so far in the media content (up to the latest media event received by manifest server 140 from dynamic metadata server 108). For example, the data structure can indicate the media events up to a mediaEventsCutoffTime, which is the time (ms time) up to which the events have been received.

In some embodiments, live origin server 142 of FIG. 1 can be configured similarly to manifest server 140 appears in FIG. 2, except with a live origin application stored in a memory of live origin server 142 instead of manifest application 144 in memory 212. Although shown as distinct for illustrative purposes, in some embodiments, manifest server 140 and live origin server 142 can be combined into one server if, for example, the manifests served by manifest server 140 need to be updated with information stored at live origin server 142.

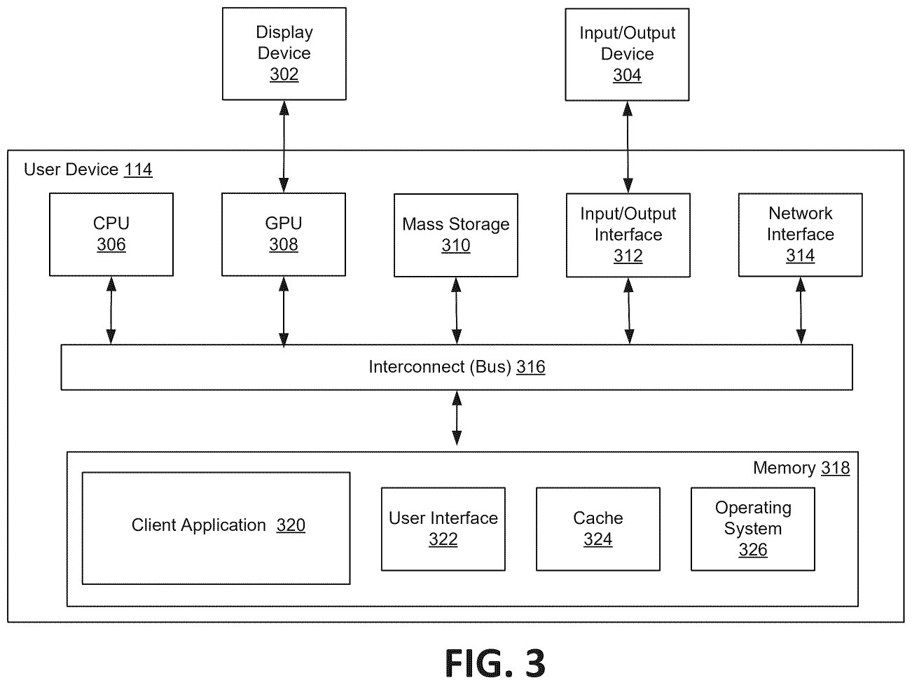

FIG. 3 is a more detailed illustration of one of user devices 114 of FIG. 1, according to various embodiments. As shown, a user device 114 can include, without limitation, a CPU 306, a graphics-processing unit (GPU) 308, an I/O interface 312, a mass storage unit 310, a network interface 314, an interconnect (bus) 316, and a memory 318.

In some embodiments, CPU 306 is configured to retrieve and execute programming instructions stored in memory 318. Similarly, CPU 306 is configured to store and retrieve application data (e.g., software libraries) residing in memory 318. Interconnect 316 is configured to facilitate transmission of data, such as programming instructions and application data, between CPU 306, GPU 308, I/O interface 312, mass storage 310, network interface 314, and memory 318.

In some embodiments, GPU 308 is configured to generate frames of video data and transmit the frames of video data to display device 302. In some embodiments, a hardware pipeline, independent of GPU 308, can perform video decoding and rendering to generate the frames of video data that are transmitted to display device 302. In some embodiments, GPU 308 can be integrated into an integrated circuit, along with CPU 306. Display device 302 can comprise any technically feasible means for generating an image for display. For example, display device 302 can be fabricated using liquid crystal display (LCD) technology, cathode-ray technology, and light-emitting diode (LED) display technology. An input/output (I/O) interface 312 is configured to receive input data from user I/O devices 304 and transmit the input data to CPU 306 via interconnect 316. For example, user I/O devices 304 can comprise one of more buttons, a keyboard, and a mouse or other pointing device. I/O interface 312 also includes an audio output unit configured to generate an electrical audio output signal. User I/O devices 304 includes a speaker configured to generate an acoustic output in response to the electrical audio output signal. In alternative embodiments, the display device 302 can include the speaker. A television is an example of a device known in the art that can display video frames and generate an acoustic output.

A mass storage unit 310, such as a hard disk drive or flash memory storage drive, is configured to store non-volatile data. A network interface 314 is configured to transmit and receive packets of data via a network (not shown). In some embodiments, network interface 314 is configured to communicate using the well-known Ethernet standard. Network interface 314 is coupled to CPU 306 via interconnect 316.

In some embodiments, memory 318 includes programming instructions and application data that comprise an operating system 326, a user interface 322, and a client application 320. Operating system 326 performs system management functions such as managing hardware devices including network interface 314, mass storage 310, I/O interface 312, and GPU 308. Operating system 326 also provides process and memory management models for user interface 322 and client application 320. User interface 322, such as a window and object metaphor, provides a mechanism for user interaction with user device 114. In some embodiments, during playback of a media content stream, user interface 322 can display supplemental content based on start and end times indicated by one or more media events. In some embodiments, while the supplemental content is being displayed, playback controls, other than pause, may not be available to the user via user interface 322. Persons skilled in the art will recognize the various operating systems and user interfaces that are well-known in the art and suitable for incorporation into user device 114.

In some embodiments, client application 320 is configured to request and receive content, such as media content associated with a live streaming event and a media events track, from live origin application 142, and client application 320 is configured to request and receive, from manifest server 140, a manifest that specifies, among other things, one or more media events that indicate the start and end times of supplemental content, via network interface 418. Further, client application 320 is configured to interpret the content and present the content via display device 302 and/or user I/O devices 304.

Streaming Live Media Content with Events

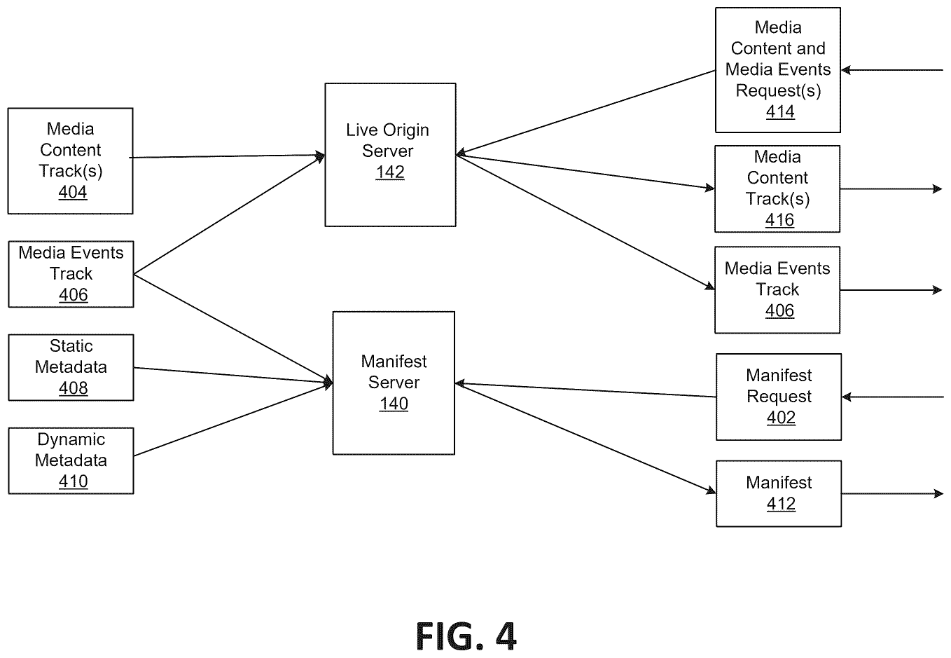

FIG. 4 is a more detailed illustration of live origin server 142 and manifest server 140 of FIG. 1, according to various embodiments. Illustratively, live origin server 142 and manifest server 140 are separate servers, but in some embodiments, live origin server 142 and manifest server 140 can be included together as a single server device.

Live origin server 142 is configured to receive and store various data associated with media content that live origin server 142 makes available. Illustratively, live origin server 142 receives, for media content associated with each live streaming event that live origin application 142 makes available, one or more media content tracks 404 and a media events track 406 from packager 106.

Media content track(s) 404 includes audio, video, and/or text streams for the media content. For example, media content track(s) 404 can include any number of video, audio, and text tracks that can be encoded differently, such as according to a bitrate ladder.

Media events track 406 is a track specifying media events for the media content of media content track(s) 404. Media events track 406 provides a real-time messaging channel for signaling media events, and in particular media events indicating the start and end times of supplemental content that occur subsequent to generation of the manifest, described above. Media events track 406 permits the streaming of such subsequent media events at the live edge independent of the playback position or even whether playback has started yet (e.g., if the manifest is prefetched). In some embodiments, the media events can include program boundary markers (e.g., splice points indicating the beginning and ending of supplemental content, such as advertisements, programs, chapters, interruptions, or extensions). In some embodiments, the media events can be specified in media events track 406 as described above in conjunction with FIG. 1.

Manifest server 140 is configured to receive a manifest request 402 and in response generate, for media content associated with a live streaming event, a manifest 412 that includes, among other things, a data structure specifying (1) the media events indicating the start and end times of supplemental content that have occurred so far in the media content based on dynamic metadata 410 (up to the latest media event received by manifest server 140 from dynamic metadata server 108), and (2) media events track 406.

Static metadata 408 is the static metadata for the media events associated with the media content associated with a live streaming event. Static metadata 408 is determined by static metadata server 116 in advance of the live stream and can include downloadable information associated with one or more tracks associated with the media content, such as a video, audio, text, and/or media event track. In some embodiments, static metadata for video and/or audio tracks can include additional information associated with bitrate, language, and other relevant information. In some embodiments, static metadata for media events tracks can include information that denotes the existence of the track.

Dynamic metadata 410 is the dynamic metadata for the media events corresponding to media content associated with a live streaming event. Dynamic metadata 410 can be determined when the live stream of the media content associated with a live streaming event begins and can include, for each media event, the availability start time, media presentation duration, presentation time offset, start segment number, segment URL templates, media timescale, and segment duration, each associated with supplemental content.

In operation, manifest application 144 can receive a request for a manifest associated with media content, shown as manifest request 402, from a client application of a user device (e.g., one of user devices 114). For example, manifest request 402 could be a request by the client application immediately before playing the media content that a user has selected, or a speculative request according to a pre-fetching technique prior to user selection of the media content. The manifest requested can be for any media content that is available, such as media content that is being live streamed in real-time when manifest request 402 is made, media content that was previously live streamed, or media content that is on-demand.

If manifest request 402 is for a manifest associated with media content that is being live streamed in real-time or was previously live streamed, manifest application 144 generates manifest 412 using static metadata 408 and dynamic metadata 410. Manifest 412 is a file that specifies one or more video tracks, audio tracks, and/or timed text tracks, which permits a client application (e.g., a client application running in one of user devices 114) to download and play back any portion of the media title in accordance with a combination of the tracks specified in the manifest. In some embodiments, one of the tracks specified by manifest 412 is media events track 406 that is associated with the same media content, which can be specified in the same manner as video, audio, or timed text tracks in manifest 412, including using URLs and a segment template. In addition, manifest 412 includes a data structure specifying the media events indicating the start and end times of supplemental content that have occurred so far in the media content associated with a live streaming event (up to the latest media event described in dynamic metadata 410). The data structure of manifest 412 indicates the mediaEventsCutoffTime, which is the time (ms time) up to which the media events are provided. For example, if the media content is currently being live streamed and the media content request 402 was received by live origin application 142 at time T54.08, then the mediaEventsCutoffTime is equal to 54.08s. Furthermore, manifest 412 includes only the media events that occur prior to the mediaEventsCutoffTime. Alternatively, if the media content was previously live streamed, the mediaEventsCutoffTime would be equal to the duration of the media content associated with the live streaming event. Because such media content is no longer being live streamed, manifest 412 would include each media event for the media content. One or more media events described in manifest 412 each include a type and timestamp and optionally also include an identifier (ID) and a duration, as described in the Media Event record table above.

After manifest 412 is generated by manifest server 140, manifest application 144 transmits manifest 412 to the requesting client application. After receiving manifest 412, the client application can download a combination of video, audio, and/or text tracks, shown as media content track(s) 416, that are specified in manifest 412. For example, the client application can select media content track(s) 416 to download based on a current network condition. Illustratively, the client application has made one or more requests 414 for media content track(s) 416 and media events track 406, which as described above is also specified in manifest 412. Notably, the delivery of events in media events track 406 is decoupled from the streaming of media content, which can begin immediately after the client application has received manifest 412. Request(s) 414 for media content track(s) 412 can be forwarded to live origin application 142. In turn, live origin application 142 transmits media content track(s) 416 and media events track 406 to the client application. In some embodiments, live origin application 142 can also cache media content track(s) 416 and media events track 406 at CDN 146 to improve the speed at which media content track(s) 416 and media events track 406 are delivered in the future to client applications that make the same request.

Thereafter, the client application can play back media content track(s) 416 that are downloaded. In some embodiments, the client application can construct a playgraph, which is a graph of playback options, in order to control the playback. The client application can play back any supplemental content indicated by media events that are specified in manifest 412 and that occur prior to the mediaEventsCutoffTime. In addition, the client application can use media events track 406 to play back future supplemental content indicated by media events that occur after the mediaEventsCutoffTime. For example, if a user rewinds the media content while the media content is being live streamed, the client application can determine the placement (i.e., start and end times) for supplemental content based on a media event that occurs prior to mediaEventsCutoffTime and is specified in manifest 412. As another example, if the user plays back the media content to a time that is after mediaEventsCutoffTime, then the client application can determine the placement (i.e., start and end times) for supplemental content based on media events after mediaEventsCutoffTime that are specified in media events track 406. In some embodiments, the supplemental content associated with the media event is embedded into the media content stream. In some other embodiments, the client application can determine and retrieve the supplemental content based on the manifest.

Advantageously, use of manifest 412 and media events track 406 can result in less complexity at the client application, and streaming delays can also be avoided. The complexity reduction arises because client applications always have all the events (so far), permitting the client application to determine whether a given position in the stream is within the program or within supplement content, or not, without having to go to the network to find out. The play delay (and seek delay) reduction comes from not needing to request media event segments to discover the nature of a seek point before starting to retrieve media.

### Client-Side Segment Splicing of Live Stream Media Content

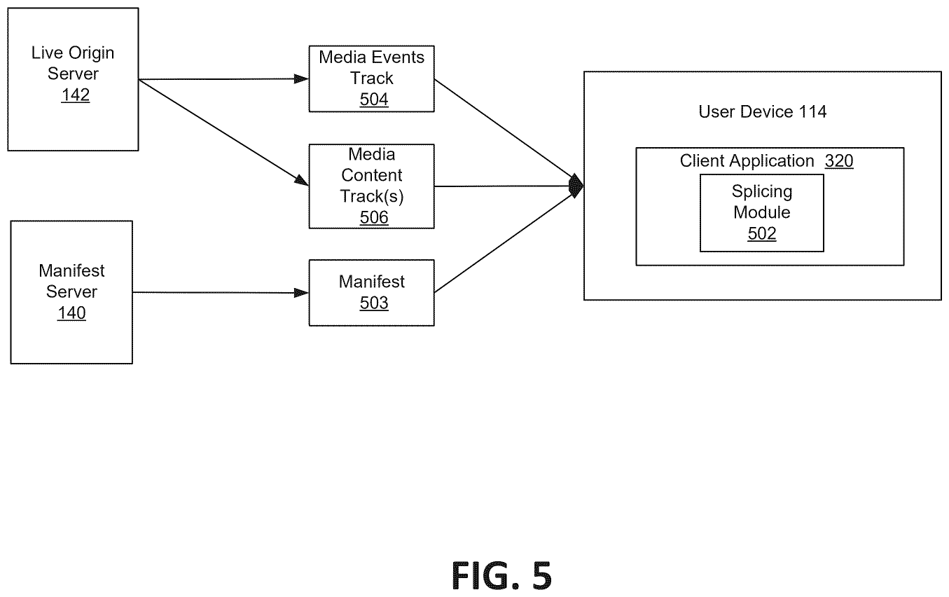

FIG. 5 is a more detailed illustration of client application 320 of FIG. 3, according to various embodiments. As shown, client application 320 includes a splicing module 502 that splices supplemental content into media content, such as media content associated with live streaming events, based on start and end times indicated by media events. Splicing module 502 can be implemented in any technically feasible manner in some embodiments. For example, splicing module 502 could be implemented using program code, such as JavaScript code, that is downloaded to client application 320.

Client application 320 is configured to download and present media content, such as media content associated with live streaming events. In operation, client application 320 can download media events and portions of media content segments, determine locations at which the indicated supplemental content can be spliced into the media content segments, and splice the supplemental content into the media content segments at the determined locations. Illustratively, client application 320 is configured to receive a manifest 503 from manifest server 140 and media events track 504 and one or more media content tracks 506 from live origin server 142. In some embodiments, client application 320 is configured to receive media events track 504 and one or more media content tracks 506 from one or more CDNs 148 within CDN 146 (not shown). Manifest 503 specifies video, audio, and/or text tracks, such as media content track(s) 506, that can be downloaded, and manifest 503 also includes a data structure specifying the media events indicating the start and end times of supplemental content that have occurred up to a mediaEventsCutoffTime, which is the time (e.g., ms time) up to which media events are provided by manifest 503. Media events track 504 is a media events track corresponding to the media content track(s) 506, and media events track 504 specifies media events that occur after the mediaEventsCutoffTime, as described above in conjunction with FIG. 4. Media content track(s) 506 are encoded audio, video, and/or text tracks, such as mp4 stream(s), for the media content.

During playback of media content, client application 320 determines media event information, such as the timestamp (start time) and duration of the associated supplemental content, for a next media event based on manifest 503 or media events track 506. For example, client application 320 can determine the end timestamp of the supplemental content by adding the duration of the supplemental content indicated by the media event to the timestamp of the supplemental content indicated by the media event, which can be specified in manifest 503 or media events track 506. The following discussion assumes that the indicated supplemental content each have a start time and an end time, such as the start times and end times of advertisement breaks, and client application 320 is splicing the supplemental content into media content. Further, in some embodiments, client application 320 can include logic for selecting supplemental content to splice into media content.

If splicing module 502 determines that the start time of the supplemental content indicated by a media event occurs during the middle of an upcoming media segment of the media content, then splicing module 502 downloads, from live origin application 142 (or a CDN if the data has been cached by the CDN), a beginning portion of the upcoming media segment that coincides with the start of the supplemental content indicated by the media event. The media content can be split into segments by an encoder (e.g., encoder 104) that creates segments that each include an I-Frame, a type of frame that does not require other frames to decode, at the beginning of the segment. In some embodiments, segments also include an I-Frame at the splice point indicated by the media event. Segments can also include other frames that are more compressed but require the I-Frame to decode. However, no frames located after the splice point can depend on frames located prior to the splice point. Segments are also sometimes referred to as “fragments.” For example, the media segments could be mp4 fragments, in which case supplemental content indicated by media events can be spliced into media content at the mp4 layer. In some embodiments, the beginning portion of the upcoming media segment is large enough to include at least a portion of a movie fragment box of the upcoming media segment. For example, the beginning portion that is downloaded could be 1 kB or smaller. The movie fragment box includes information related to each frame of video in the media segment, including the size of the frames and the timing of each frame, as well as the length of the movie fragment box itself. In some embodiments, only a portion of the movie fragment box is downloaded. In this case, the client application can determine the length of the movie fragment box based on the portion downloaded in order to download the rest of the movie fragment box containing the relevant information of the frames needed. In some embodiments, the movie fragment box can include (1) a movie fragment header that includes a sequence number that is increased for every subsequent media segment in the order in which the media segments occur, and (2) zero or more track fragment boxes that provide information related to a track fragment presentation time, duration, and physical location of associated samples in a media data box.

Based on the information included in the movie fragment box, splicing module 502 downloads each frame of the upcoming media segment that occurs before the start time indicated by the media event from live origin application 142 (again, if the data has not been cached by a CDN). For example, if the start time indicated by the media event is 1.0 seconds into the upcoming media segment, one second worth of frames can be downloaded. In such a case, the specific frames before the start time indicated by the media event that need to be downloaded can be computed from the size of the frames and the timing of each frame specified in the movie fragment box. Splicing module 502 causes client application 320 to continue playback of the downloaded frames of the upcoming media segment, followed by the entirety of the supplemental content indicated by the media event. In some embodiments, the media content is played back following splicing, such as after ad break removal. In some embodiments, splicing module 502 causes the playback by modifying the movie fragment box to remove reference to frames that were not downloaded, and then transmitting the modified movie fragment box to a player, which can be included in or separate from client application 320, that uses the modified movie fragment box to play back the downloaded frames. In such cases, the playback is agnostic to the specific player being used, because the player will receive what appears to be ordinary streaming media content data, assuming the player is able to accept movie fragments with disjoint time spans. Accordingly, the techniques for splicing media events into media content that are disclosed herein can work across different types of players.

During playback of the supplemental content indicated by the media event, the splicing module 502 determines a second media segment that coincides with the end time of the supplemental content indicated by the media event. Splicing module 502 downloads a beginning portion of the second media segment that coincides with the end of the supplemental content indicated by the media event from live origin application 142 (again, if the data has not been cached by a CDN). In some embodiments, the beginning portion of the second media segment is large enough to include the movie fragment box of the second media segment. For example, the beginning portion that is downloaded can be 1 kB or smaller. Based on the information included in the movie fragment box of the second media segment, splicing module 502 downloads each frame of the second media segment that occurs after the end time of the supplemental content indicated by the media event from the live origin application 142 (again, if the data has not been cached by a CDN). For example, if the end time of the supplemental content indicated by the media event is 1.5 seconds into the second media segment that is 2 seconds long, the last 0.5 seconds worth of frames in the second media segment can be downloaded. In such a case, the specific frames after the end time of the supplemental content indicated by the media event that need to be downloaded can be computed from the size of the frames and the timing of each frame specified in the movie fragment box. Client application 320 continues playback of the downloaded frames of the second segment after the playback of the supplemental content indicated by the media event concludes. In some embodiments, splicing module 502 causes such playback by modifying the movie fragment box to remove reference to frames that were not downloaded, and then transmitting the modified movie fragment box to a player, which can be included in or separate from client application 320, that uses the modified movie fragment box to play back the downloaded frames after the playback of the supplemental content indicated by the media event concludes.

The splicing techniques described above can be repeated for each media event in manifest 503 and media events track 506. In some embodiments, the whole of the segment is downloaded and then the movie fragment box is modified to remove references to frames after the first time indicated by the media event. The removed frames are discarded. The resulting output is the same as the embodiments above, but slightly less efficient because of the extra data downloaded and discarded.

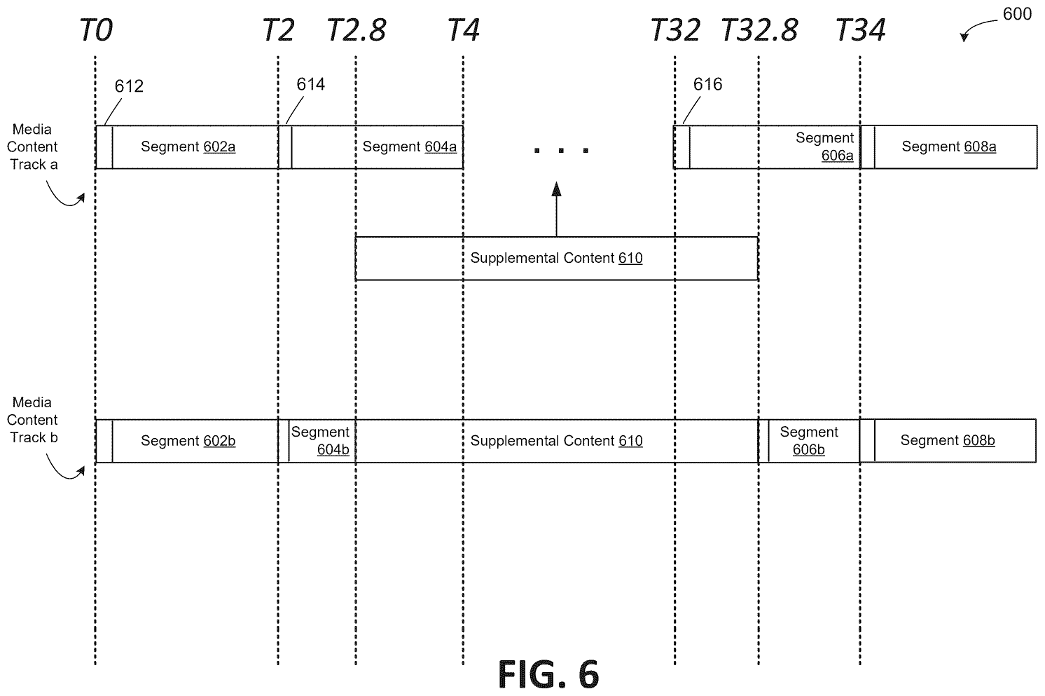

FIG. 6 illustrates a timeline diagram of exemplary media segments and supplemental content indicated by media events, according to various embodiments. As shown, timeline 600 illustrates the times of media segments 602a-b, 604a-b, 606a-b, and 608a-b, as well as supplemental content 610. Timeline 600 includes timestamp markers at time value 0 seconds, 2 seconds, 2.8 seconds, 4 seconds, 30 seconds, 32.8 seconds, and 34 seconds, represented by the dotted lines and T values, for illustrative purposes. Media segments 602, 604a, 606a, and 608 are each 2 seconds in length. For example, media segment 602 starts at T0 and ends at T2, media segment 604a starts at T2 and ends at T4, and media segment 606a starts at T32 and ends at T34. Movie fragment boxes 612, 614, and 616 are at beginning portions of media segments 602a, 604a, and 606a, respectively. Each other media segment illustrated can also include a movie fragment box located at a beginning portion of the media segment.

For illustrative purposes only, the media segments have been divided into two tracks or streams—media content track A and media content track B—to show a before and after effect of event insertion, as described above in conjunction with FIG. 5. Media content track A represents the media segments without supplemental content 610 inserted into the media content track. Media content track B represents the media segments after supplemental content 610 has been inserted into the media track, as described above in conjunction with FIG. 5.

Illustratively, client application 320 of FIG. 5 has determined that supplemental content 610 has a timestamp at T2.8 and a duration of 30 seconds based on media event information about supplemental content 610 in a manifest or media events track. Splicing module 502 of client application 320 determines, during playback of media content track A, that the next supplemental content, supplemental content 610, coincides with the middle of media segment 604a because the start of media segment 604a is the closest segment to the timestamp T2.8 based on the default cadence of media segments boundaries occurring every 2 seconds.

Because supplemental content 610 coincides with media segment 604a, splicing module 502 determines media segment 604a needs to be spliced. Splicing module 502 downloads enough bits of media segment 604a to download a movie fragment box 614 of media segment 604a. Using information within movie fragment box 614, splicing module 502 downloads each frame of media segment 604a until the timestamp T2.8, resulting in the shorter media segment 604b in media content track B. Splicing module 502 also downloads supplemental content 610. Splicing module 502 causes client application 320 to playback the downloaded frames of segment 604b and then supplemental content 610, which can include modifying the movie fragment box to remove references to frames that were not downloaded, as described above in conjunction with FIG. 5.

During playback, client application 320 determines the end time of supplemental content 610 by adding the timestamp of 2.8 seconds to the duration of 30 seconds, which is equal to 32.8 seconds. Because the playback of supplemental content 610 will conclude at T32.8, which is not a segment boundary based on the default cadence, splicing module 502 determines media segment 606a, which has a starting playback at T32, coincides with the conclusion of supplemental content 610. Splicing module 502 downloads enough bits of media segment 606a to download a movie fragment box 616 of media segment 606a. Using information within movie fragment box 616, splicing module 502 downloads each frame of media segment 606a after the timestamp T32.8, resulting in the shorter media segment 606b in media content track B. Splicing module 502 can cause client application 320 to play back the downloaded frames of segment 606b after the conclusion of supplemental content 610, which can include modifying the movie fragment box to remove references to frames that were not downloaded, as described above in conjunction with FIG. 5. As shown in media content track B, supplemental content 610 has been sliced into an arbitrary point between segment 604b and segment 606b without needing to change the default cadence. For example, the boundaries of segment 608b remain at 2 second intervals. The default cadence of 2 seconds is for illustrative purposes and not meant to be limiting. Any cadence duration can be chosen for the purposes described above.

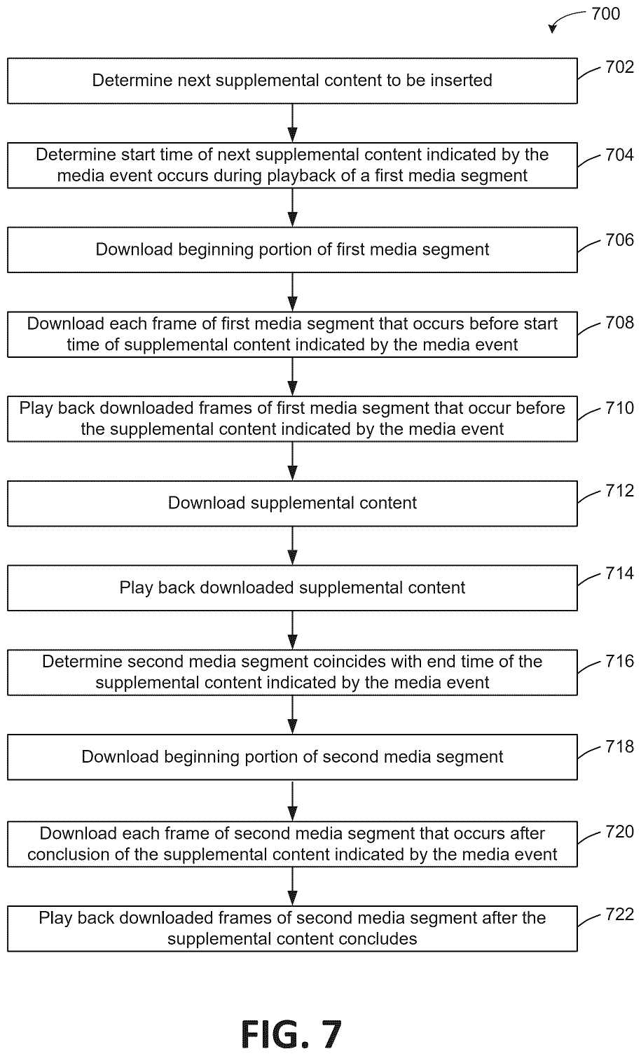

FIG. 7 is a flow diagram of method steps for splicing supplemental content indicated by a media event into media content, according to various embodiments. Although the method steps are described in conjunction with the systems of FIG. 1-6, persons skilled in the art will understand that any system configured to perform the method steps in any order falls within the scope of the various embodiments.

As shown, a method 700 begins at step 702, where client application 320, of a user device 114, determines the next supplemental content indicated by a media event to be inserted into the media content, during playback of the media content. The media content can be encoded into media segments for delivery as a live stream of media content. Client application 320 determines information, such as the timestamp and duration, associated with the next supplemental content indicated by a media event based on a manifest or a media events track, described above in conjunction with FIGS. 4-5. Client application 320 determines the end timestamp of the supplemental content indicated by a media event by adding the duration of the supplemental content to the timestamp of the supplemental content.

At step 704, client application 320 (and, specifically, splicing module 502 of client application 320) determines a start time of the next supplemental content indicated by a media event occurs during playback of a first media segment based on the manifest or media events track. Although described herein primarily with respect to the start time of the next supplemental content as a reference example, in some embodiments, client application 320 can determine the end time of supplemental content. For example, in order to extract supplemental content from one live stream and insert the extracted supplemental content into another live stream, an end time of the supplemental content could be determined.

At step 706, client application 320 downloads a beginning portion of the first media segment. The beginning portion of the first media segment includes a movie fragment box of the first media segment. For example, the beginning portion that is downloaded can be as small as 1 kB. The movie fragment box includes information related to each frame of video in the media segment, including the size of the frames and the timing of each frame.

At step 708, client application 320 downloads each frame of the media segment that occurs before the start time of the supplemental content indicated by the media event based on information included in the movie fragment box. Client application 320 can download each frame of the media segment that occurs before the start time of the supplemental content indicated by the media event by requesting such frames from live origin application 142. The specific frames before the start time of the supplemental content indicated by the media event that need to be downloaded can be computed from the size of the frames and the timing of each frame specified in the movie fragment box.

At step 710, client application 320 plays back each downloaded frame of the media segment that occurs before the supplemental content indicated by the media event. In some embodiments, client application 320 (and, specifically, splicing module 502) can also modify the movie fragment box of the first media segment to remove reference to frames that were not downloaded, and then cause playback of the downloaded frames before the supplemental content indicated by the media event by transmitting the modified movie fragment box to a player (e.g., a player within or separate from client application 320) that uses the modified movie fragment box to play back the downloaded frames before the supplemental content indicated by the media event.

At step 712, client application 320 downloads the supplemental content indicated by the media event for playback. At step 714, client application 320 plays back the supplemental content at the start time. At step 716, during playback of the supplemental content, client application 320 (and, specifically, splicing module 502 of client application 320) determines a second media segment coincides with an end time of the supplemental content indicated by the media event.

At step 718, client application 320 downloads a beginning portion of the second media segment that coincides with the end time of the supplemental content indicated by the media event. The beginning portion of the second media segment includes a movie fragment box of the second media segment.

At step 720, based on the information included in the movie fragment box of the second media segment, client application 320 downloads each frame of the second media segment that occurs after the end time of the supplemental content indicated by the media event. Client application 320 can download each frame of the media segment that occurs before the start time of the supplemental content indicated by the media event by requesting such frames from live origin application 142. The specific frames after the end time of the supplemental content indicated by the media event that need to be downloaded can be computed from the size of the frames and the timing of each frame specified in the movie fragment box. Although described herein primarily with respect to downloading the media content just after the supplemental content as a reference example, in the case where an end time of supplemental content is instead determined (described above in conjunction with step 704), the very start of supplemental content can be downloaded instead.

At step 722, client application 320 continues playback of the downloaded frames of the second segment after the playback of the supplemental content concludes. In some embodiments, client application 320 (and, specifically, splicing module 502) can also modify the movie fragment box of the second media segment to remove reference to frames that were not downloaded, and then cause playback of the downloaded frames after the playback of the supplemental content concludes by transmitting the modified movie fragment box to a player (e.g., a player within or separate from client application 320) that uses the modified movie fragment box to play back the downloaded frames after the playback of the supplemental content concludes.

In sum, the disclosed techniques provide client-side splicing of segments of media content, including media content associated with live streaming events. During playback of media content, a client application determines the next supplemental content to be inserted into the media content based on media event information from an associated manifest or media events track. The client application downloads a portion of a first segment of media content that coincides with a start time of the next supplemental content indicated by the media event and includes a first movie fragment box. The first movie fragment box includes information related to each frame in the segment, including the size of the frames and the timing of each frame. Based on the information included in the first movie fragment box and the information associated with the media event, the client application downloads the frames of the segment that occur before the start time of the supplemental content indicated by the media event. The client application plays back the downloaded frames and then the supplemental content t. Based on the length of the supplemental content, which the client application determines from the media event included in the manifest or the media events track, the client application determines a second segment of the media content that coincides with the end time of the supplemental content indicated by the media event. The client application downloads a portion of the second segment that coincides with the end time of the supplemental content indicated by the media event and includes a second movie fragment box. The second movie fragment box includes information related to each frame in the second segment, including the size of the frames and the timing of each frame. Based on the information included in the second movie fragment box and the information associated with the media event, the client application downloads the frames in the second segment that occur after the end time of the supplemental content indicated by the media event. The client application plays back the downloaded frames of the second segment after the playback of the supplemental content concludes.

At least one technical advantage of the disclosed techniques relative to the prior art is that the disclosed techniques allow arbitrary splice points for inserting supplemental content into media content associated with a live streaming event, while maintaining a fixed cadence based on when the next media segment occurs. By maintaining a fixed cadence, the disclosed techniques allow for efficient mapping of media events, such as indications of start and end times of supplemental content to the segment numbers of media content without manifest polling. Furthermore, by supporting arbitrary splicing points for insertion of supplemental content into media content, the disclosed techniques allow for greater control and more efficient supplemental content insertion. Additionally, because the supplemental content insertion is performed by the client application, the disclosed techniques utilize the processing power of the client device, rather than burdening the server, and the disclosed techniques also allow for real-time targeting and personalization of supplemental content based on the preferences of a client application or a user of a client application. These technical advantages represent one or more technological improvements over prior art approaches.

1. In some embodiments, a computer-implemented method for client-side splicing of a media content stream comprises determining supplemental content begins at a first time indicated by a media event, downloading, based on the first time, a beginning portion of a first segment of the media content, wherein the first time coincides with a playback time period of the first segment, downloading, based on information included in the beginning portion of the first segment, one or more frames of the first segment that occur prior to the first time, and outputting the one or more frames of the first segment that occur prior to the first time.

2. The computer-implemented method of clause 1, further comprising determining, based on the length of the supplemental content indicated by the media event, a second time at which the supplemental content ends, downloading, based on the second time, a beginning portion of a second segment of the media content, wherein the second time coincides with a second playback time period of the second segment, downloading, based on information included in the beginning portion of the second segment, one or more frames of the second segment associated with a playback time period that occur after the second time, and outputting the one or more frames of the second segment associated with the playback time period that occur after the second time.

3. The computer-implemented method of clauses 1 or 2, further comprising modifying the information included in the beginning portion of the first segment based on the first time.

4. The computer-implemented method of any of clauses 1-3, wherein the information associated with the beginning portion of the first segment specifies a size and a timing of each frame included in the first segment, and the method further comprises determining the one or more frames of the first segment that occur prior to the first time based on the size and timing of each frame in the first segment.

5. The computer-implemented method of any of clauses 1-4, wherein the beginning portion of the first segment includes a movie fragment box, and wherein the information included in the beginning portion of the first segment is included in the movie fragment box.

6. The computer-implemented method of any of clauses 1-5, further comprising modifying the information included in the beginning portion of the first segment to remove one or more references to one or more frames after the first time.

7. The computer-implemented method of any of clauses 1-6, wherein modifying the information comprises modifying a movie fragment header included in a movie fragment box.

8. The computer-implemented method of any of clauses 1-7, wherein the supplemental content is one of an advertisement break event, an alternative content event, or a blackout event.

9. The computer-implemented method of any of clauses 1-8, wherein the media content is associated with a live streaming event.

10. The computer-implemented method of any of clauses 1-9, further comprising outputting the supplemental content from the first time.

11. In some embodiments, one or more non-transitory computer-readable media include instructions that, when executed by one or more processors, cause the one or more processors to perform the steps of determining supplemental content begins at a first time indicated by a media event, downloading, based on the first time, a beginning portion of a first segment of the media content, wherein the first time coincides with a playback time period of the first segment, downloading, based on information included in the beginning portion of the first segment, one or more frames of the first segment that occur prior to the first time, and outputting the one or more frames of the first segment that occur prior to the first time.

12. The one or more non-transitory computer-readable media of clause 11, further comprising determining, based on the length of the supplemental content indicated by the media event, a second time at which the supplemental content ends, downloading, based on the second time, a beginning portion of a second segment of the media content, wherein the second time coincides with a second playback time period of the second segment, downloading, based on information included in the beginning portion of the second segment, one or more frames of the second segment associated with a playback time period that occur after the second time, and outputting the one or more frames of the second segment associated with a playback time period that occur after the second time.

13. The one or more non-transitory computer-readable media of clauses 11 or 12, wherein the instructions, when executed by one or more processors, further cause the one or more processors to perform the step of modifying the information included in the beginning portion of the first segment based on the first time.

14. The one or more non-transitory computer-readable media of any of clauses 11-13, wherein the information associated with the beginning portion of the first segment specifies a size and a timing of each frame in the first segment, and wherein the instructions, when executed by one or more processors, further cause the one or more processors to perform the step of determining the one or more frames of the first segment that occur after the first time based on the size and timing of the one or more frames in the first segment.

15. The one or more non-transitory computer-readable media of any of clauses 11-14, wherein the beginning portion of the first segment includes a movie fragment box, and wherein the information included in the beginning portion of the first segment is included in the movie fragment box.

16. The one or more non-transitory computer-readable media of any of clauses 11-15, wherein the instructions, when executed by one or more processors, further cause the one or more processors to perform the step of modifying the information included in the beginning portion of the first segment to remove one or more references to one or more frames after the first time.

17. The one or more non-transitory computer-readable media of any of clauses 11-16, wherein the media content is associated with a video-on-demand content.

18. The one or more non-transitory computer-readable media of any of clauses 11-17, wherein the supplemental content comprises advertisement break content.

19. The one or more non-transitory computer-readable media of any of clauses 11-18, wherein the step of determining the supplemental content begins at the first time indicated by the media event is based on information associated with a manifest or a media events track.

20. In some embodiments, a system comprises one or more memories storing instructions, and one or more processors coupled to the one or more memories that, when executing the instructions, perform the steps of determining supplemental content begins at a first time indicated by a media event, downloading, based on the first time, a beginning portion of a first segment of the media content, wherein the first time coincides with a playback time period of the first segment, downloading, based on information included in the beginning portion of the first segment, one or more frames of the first segment that occur prior to the first time, and outputting the one or more frames of the first segment that occur prior to the first time.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for client-side splicing of a media content stream, the method comprising:
determining supplemental content begins at a first time indicated by a media event;
downloading, based on the first time, a beginning portion of a first segment of the media content, wherein the first time coincides with a playback time period of the first segment;
downloading, based on information included in the beginning portion of the first segment, one or more frames of the first segment that occur prior to the first time; and
outputting the one or more frames of the first segment that occur prior to the first time.

2. The computer-implemented method of claim 1, further comprising:
determining, based on the length of the supplemental content indicated by the media event, a second time at which the supplemental content ends;
downloading, based on the second time, a beginning portion of a second segment of the media content, wherein the second time coincides with a second playback time period of the second segment;
downloading, based on information included in the beginning portion of the second segment, one or more frames of the second segment associated with a playback time period that occur after the second time; and
outputting the one or more frames of the second segment associated with the playback time period that occur after the second time.

3. The computer-implemented method of claim 1, further comprising modifying the information included in the beginning portion of the first segment based on the first time.

4. The computer-implemented method of claim 1, wherein the information associated with the beginning portion of the first segment specifies a size and a timing of each frame included in the first segment, and the method further comprises determining the one or more frames of the first segment that occur prior to the first time based on the size and timing of each frame in the first segment.

5. The computer-implemented method of claim 1, wherein the beginning portion of the first segment includes a movie fragment box, and wherein the information included in the beginning portion of the first segment is included in the movie fragment box.

6. The computer-implemented method of claim 1, further comprising modifying the information included in the beginning portion of the first segment to remove one or more references to one or more frames after the first time.

7. The computer-implemented method of claim 6, wherein modifying the information comprises modifying a movie fragment header included in a movie fragment box.

8. The computer-implemented method of claim 1, wherein the supplemental content is one of an advertisement break event, an alternative content event, or a blackout event.

9. The computer-implemented method of claim 1, wherein the media content is associated with a live streaming event.

10. The computer-implemented method of claim 1, further comprising outputting the supplemental content from the first time.

11. One or more non-transitory computer-readable media including instructions that, when executed by one or more processors, cause the one or more processors to perform the steps of:
determining supplemental content begins at a first time indicated by a media event;
downloading, based on the first time, a beginning portion of a first segment of the media content, wherein the first time coincides with a playback time period of the first segment;
downloading, based on information included in the beginning portion of the first segment, one or more frames of the first segment that occur prior to the first time; and
outputting the one or more frames of the first segment that occur prior to the first time.

12. The one or more non-transitory computer-readable media of claim 11, further comprising:
determining, based on the length of the supplemental content indicated by the media event, a second time at which the supplemental content ends;
downloading, based on the second time, a beginning portion of a second segment of the media content, wherein the second time coincides with a second playback time period of the second segment;
downloading, based on information included in the beginning portion of the second segment, one or more frames of the second segment associated with a playback time period that occur after the second time; and
outputting the one or more frames of the second segment associated with a playback time period that occur after the second time.

13. The one or more non-transitory computer-readable media of claim 11, wherein the instructions, when executed by one or more processors, further cause the one or more processors to perform the step of modifying the information included in the beginning portion of the first segment based on the first time.

14. The one or more non-transitory computer-readable media of claim 11, wherein the information associated with the beginning portion of the first segment specifies a size and a timing of each frame in the first segment, and wherein the instructions, when executed by one or more processors, further cause the one or more processors to perform the step of determining the one or more frames of the first segment that occur after the first time based on the size and timing of the one or more frames in the first segment.

15. The one or more non-transitory computer-readable media of claim 11, wherein the beginning portion of the first segment includes a movie fragment box, and wherein the information included in the beginning portion of the first segment is included in the movie fragment box.

16. The one or more non-transitory computer-readable media of claim 11, wherein the instructions, when executed by one or more processors, further cause the one or more processors to perform the step of modifying the information included in the beginning portion of the first segment to remove one or more references to one or more frames after the first time.

17. The one or more non-transitory computer-readable media of claim 11, wherein the media content is associated with a video-on-demand content.

18. The one or more non-transitory computer-readable media of claim 11, wherein the supplemental content comprises advertisement break content.

19. The one or more non-transitory computer-readable media of claim 11, wherein the step of determining the supplemental content begins at the first time indicated by the media event is based on information associated with a manifest or a media events track.

20. A system comprising:
one or more memories storing instructions; and
one or more processors coupled to the one or more memories that, when executing the instructions, perform the steps of:
determining supplemental content begins at a first time indicated by a media event;
downloading, based on the first time, a beginning portion of a first segment of the media content, wherein the first time coincides with a playback time period of the first segment;
downloading, based on information included in the beginning portion of the first segment, one or more frames of the first segment that occur prior to the first time; and
outputting the one or more frames of the first segment that occur prior to the first time.
